(19) United States
(12) Patent Application Publication
(10) Pub. No.: US 2008/0245466 A1
(43) Pub. Date: Oct. 9, 2008

(54) Method of Making A Slow Cooker Liner With Securing Band

(76) Inventors: Michael D. Schmal, Orwigsburg, PA (US); Ernest E. Bachert, Orwigsburg, PA (US)

Correspondence Address: Pepper Hamilton LLP, 400 Berwyn Park, 899 Cassatt Road, Berwyn, PA, 19312-1183, US

(21) Appl. No.: 12/062,924

(22) Filed: Apr. 4, 2008

Related U.S. Application Data
(60) Provisional application No. 60/910,312, filed on Apr. 5, 2007.

(51) Int. Cl. B32B 37/00

(52) U.S. Cl. 156/73.1; 156/218

(57) ABSTRACT

An improved liner that may be placed in a cooking apparatus, such as a slow cooker, to form and maintain a barrier between the slow cooker and food contained therein. The liner includes a securing band attached around the perimeter of the open top end of the liner and that engages an outside of the slow cooker to form a secure and snug fit of the liner to the slow cooker. The securing band may include an elastic band and/or a heat shrink band. The securing band holds the liner in place when the liner is placed within a container of the slow cooker and the top portion is folded over the rim of the slow cooker. This reduces and/or eliminates the problem of the liner settling or falling back into the slow cooker or the food contained therein. In addition, the liner may include a shaped or contoured bottom edge to further enhance the performance of the liner.

### CROSS REFERENCE TO RELATED APPLICATIONS

This application claims the benefit of U.S. Application No. 60/910,312, filed Apr. 5, 2007, the entirety of which is incorporated by reference herein.

### TECHNOLOGY FIELD

The present invention relates in general to the culinary arts, and more particularly, to a method of making a slow cooker liner having a securing band that helps form an improved barrier between food placed within the liner and the interior surfaces of a food cooking apparatus, such as a slow cooker.

### BACKGROUND

Slow cookers provide a simple cooking method for cooking particular dishes, including stews, pot roasts, chili, soups, and the like. One popular type of slow cooker is known as a crock pot. Although slow cookers cook these types of dishes in a desirable fashion, the ceramic cooking pot of the slow cooker can often become encrusted with burned on food residue which is difficult to clean. Accordingly, disposable liners may be placed inside the container of the slow cooker to cover the interior surfaces of the slow cooker thereby keeping the food separate from the surfaces of the slow cooker. These liners may include bag-shaped liners having a tubular body sealed at a bottom end and at the sides, and having an opening at a top end. When a user is finished with the slow cooker, the disposable liners can be removed and discarded, leaving little or no clean up.

The known liners for slow cookers, however, have certain shortcomings. For example, when the liners are placed in the slow cooker, excess material near the top or open end of the liner loosely folds over the rim of the slow cooker. This excess and loose liner material may interfere with cooking and may be aesthetically displeasing to the user. Also, the liner may fall into the slow cooker. Furthermore, loose liners tend to settle down into the contents of the crock pot, creating a mess.

The shape of conventional bag-shaped liners has also been a problem. For example, use of known bag-shaped liners may result in food getting trapped in the corners of the liner thereby making it difficult for the user to remove the contents from corner areas of the liner.

There is a need therefore, for an improved slow cooker liner and method for making the improved slow cooker liner. In particular, there is a need for a simple, flexible, replaceable, and durable slow cooker liner having a securing means around the opening perimeter of the liner to keep the excess liner fit snuggly around the outside of the slow cooker, which would be aesthetically pleasing, and that also prevents the liner from falling and/or settling down into the slow cooker. Additionally, there is a need for a slow cooker liner that prevents food from being trapped in the corners of the liner and allows better utility for the liner as far as getting food out of the container.

### SUMMARY

Certain aspects of the present invention are directed to methods for making a disposable slow cooker lining system to cover the interior surface of a slow cooker comprising: forming a generally tubular, or bag-like shaped liner comprising: a closed bottom end, one or more side walls extending upwardly from the closed bottom end, and an open top end; and adhering a securing band to the liner proximate the open top end of the liner. The methods may further comprise forming the closed bottom end of the liner by folding a sheet of liner material along its longitudinal length to form a folded liner sheet. Side walls may be formed by sealing one or more edges of a sheet of liner material. The one or more edges may be sealed by ultrasonic welding or heat sealing.

In certain embodiments, the securing band may be an elastic securing band and the elastic securing band may be stretched prior adhering to the liner. The securing band may be adhered to the liner using a high temperature adhesive, ultrasonic welding, heat sealing, or stitching with high temperature thread.

Additionally, a contoured bottom edge may be formed at the closed bottom end. The contoured bottom edge may be formed to comprise a flat bottom end and one or more contoured edges formed between the flat bottom edge and one or more of the side walls. The one or more contoured edges may be extended outward and upward from an opposite end of the flat bottom edge and merge to join with the one or more side walls. The one or more contoured edges may merge and join at its opposite end with an edge of the side walls.

Methods may further comprise enclosing the securing band within the one or more side wall. For example, the securing band may be enclosed within the one or more sidewalls by folding one or more of the edges of the liner sheet over the securing band. In other embodiments, the securing band may be enclosed by placing a liner strip over the securing band. The slow cooker lining system may be able to withstand temperatures of up to about 400° F.

Additional aspects of the present invention may be directed to methods for making a disposable slow cooker lining system to cover the interior surface of a slow cooking apparatus comprising: providing a sheet of liner material; placing an elastic band, under tension, onto the sheet of liner material proximate to each edge of the sheet of liner material; enclosing the elastic band within the liner material; attaching the elastic band to the liner material; folding the sheet of liner material along its longitudinal length to form a closed bottom end and an open top end; and sealing the edges of the sheet of liner material to form one or more side walls extending between the closed bottom end and the open top end. Methods may further comprise cutting the sheet of liner material at the heat sealed edges to form a generally tubular, or bag-like shaped structure.

In certain embodiments, the elastic band may be enclosed with the liner material by folding the edges of the sheet of liner material over the securing band and attaching the distal end to the sheet of liner material. Additionally, the securing band may be attached to the edges of the sheet of liner material. In other embodiments, the elastic band may be enclosed within the liner material by placing a liner strip over the securing band and attaching the edges of the liner strip to the sheet of liner material. Additionally, the securing band may be attached to the liner strip. The elastic band may be attached to the liner material by ultrasonic welding or heat sealing. Venting holes may also be formed on the side walls. The slow cooker lining system may be able to withstand temperatures of up to about 400° F.

Additional aspects of the present invention may be directed to methods for making a disposable slow cooker lining system to cover the interior surface of a slow cooking apparatus comprising: forming a generally tubular, or bag-like shaped liner comprising: a closed bottom end, one or more side walls extending upwardly from the closed bottom end, and an open top end having an exterior diameter; forming a generally tubular elastic securing band having a first diameter less than the exterior diameter of the open top end; applying tension to the elastic securing band to expand the first diameter to a second diameter wherein the second diameter is greater than the exterior diameter of the open top end; and securing the elastic securing band to the side walls proximate to the open top end.

Additional features and advantages of the invention will be made apparent from the following detailed description of illustrative embodiments that proceeds with reference to the accompanying drawings.

### BRIEF DESCRIPTION OF THE DRAWINGS

The foregoing and other aspects of the present invention will become apparent from the following detailed description of the invention when considered in conjunction with the accompanying drawings. For the purpose of illustrating the invention, there is shown in the drawings embodiments that are presently preferred, it being understood, however, that the invention is not limited to the specific instrumentalities disclosed. In the drawings:

FIG. 1 is a perspective view of an exemplary slow cooker liner placed within a slow cooker;

FIG. 2 is an exploded perspective view of the slow cooker and slow cooker liner of FIG. 1;

FIG. 3 is a cross sectional view of the slow cooker liner of FIG. 1;

FIG. 4 is a front perspective view of another exemplary slow cooker liner having an elastic securing band and a contoured bottom edge in accordance with an embodiment of the present invention;

FIG. 5 is a front perspective view of another exemplary slow cooker liner having a heat shrink securing band and a contoured bottom edge in accordance with an embodiment of the present invention;

FIG. 6 is a front perspective view of another exemplary slow cooker liner in accordance with an embodiment of the present invention;

FIG. 7 is a front perspective view of another exemplary slow cooker liner in accordance with an embodiment of the present invention;

FIG. 8A is a cross sectional view of an exemplary slow cooker liner with side walls folded outward over the securing band;

FIG. 8B is a cross sectional view of an exemplary slow cooker liner with side walls folded inward over the securing band;

FIG. 9A is a cross sectional view of an exemplary slow cooker liner with a liner strip placed over the securing band external to the side wall;

FIG. 9B is a cross sectional view of an exemplary slow cooker liner with a liner strip placed over the securing band internal to the side wall;

FIG. 10 is a front perspective view of an exemplary slow cooker liner in accordance with an embodiment of the present invention;

FIG. 11A is a cutaway front view of a securing band attached to a folded portion of a sidewall along its length;

FIG. 11B is a cutaway front view of a securing band attached to a folded portion of a sidewall at its end;

FIG. 12 illustrates an exemplary method of manufacturing a slow cooker liner having an elastic securing band;

FIG. 13 illustrates another exemplary method of manufacturing a slow cooker liner having an elastic securing band;

FIG. 14A illustrates an exemplary method of placing a securing band onto a sheet of liner material;

FIG. 14B is a cross sectional view of an exemplary sheet of liner material with side walls folded outward over the securing band;

FIG. 15A illustrates another exemplary method of placing a securing band onto a sheet of liner material;

FIG. 15B is a cross sectional view of an exemplary slow cooker liner with a liner strip placed over the securing band;

FIG. 16 illustrates an exemplary method of sealing a securing band onto a sheet of liner material;

FIG. 17A illustrates an exemplary method of folding a sheet of liner material along its longitudinal length;

FIG. 17B illustrates another exemplary method of folding a sheet of liner material along its longitudinal length;

FIG. 18 illustrates an exemplary method of sealing the edges of the sheet of liner material to form one or more side walls extending upwardly from the closed bottom end; and

FIG. 19 a front perspective view of an exemplary slow cooker liner in accordance with an embodiment of the present invention.

### DETAILED DESCRIPTION OF ILLUSTRATIVE EMBODIMENTS

The present invention is directed to a slow cooker liner having a securing band, for forming and maintaining an improved barrier between a cooking apparatus—such as a slow cooker—and food disposed therein. The slow cooker liner may be designed and constructed to be disposed within the slow cooker and the open top end may be folded outward over the rim of the slow cooker such that the securing band engages an outer surface of the slow cooker. The slow cooker liner may include a size and shape to substantially conform to the container (i.e., the interior surfaces) of a slow cooker.

In accordance with embodiments of the present invention, the slow cooker liner may have a securing band incorporated around a perimeter of an open top end of the liner. The securing band may help keep excess liner material proximate an upper portion of the liner secured and snuggly fit over the rim and around the outside of the slow cooker. The securing band may keep any excess liner out of the way of the cooking process and improve the aesthetic appearance of the slow cooker liner. Also, the securing band may reduce and/or prevent the liner from falling into and/or settling down into the container of the slower cooker and the food contained therein.

The slow cooker liner and securing band are preferably suitable for high temperature applications. As used herein, high temperature means the slow cooker liner and securing band are preferably made from materials suitable for use in high temperature applications of between about 100° F. and about 400° F. Preferably, the improved high temperature liner having a securing band can withstand temperatures up to about 400° F.

In addition, the slow cooker liner may be formed having a contoured bottom edge, thereby preventing food from becoming trapped in the bottom corners of the liner. Accordingly, the improved slow cooker liner having a contoured bottom edge also helps improve food safety, helps maintain food quality, reduces shrinkage, and may reduce labor costs and resource consumption.

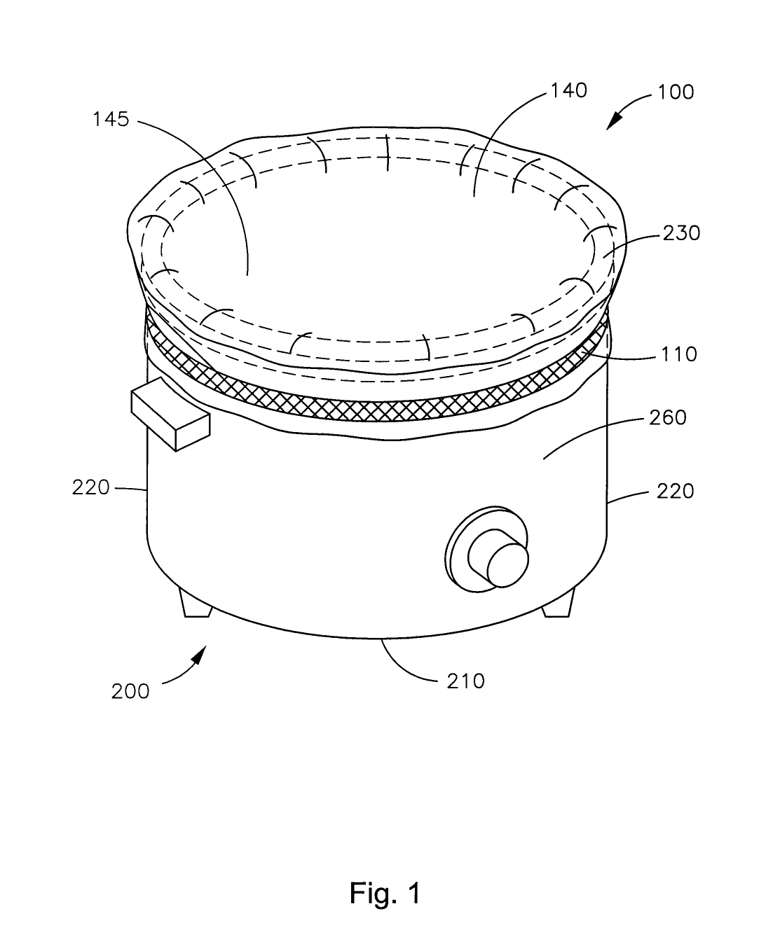

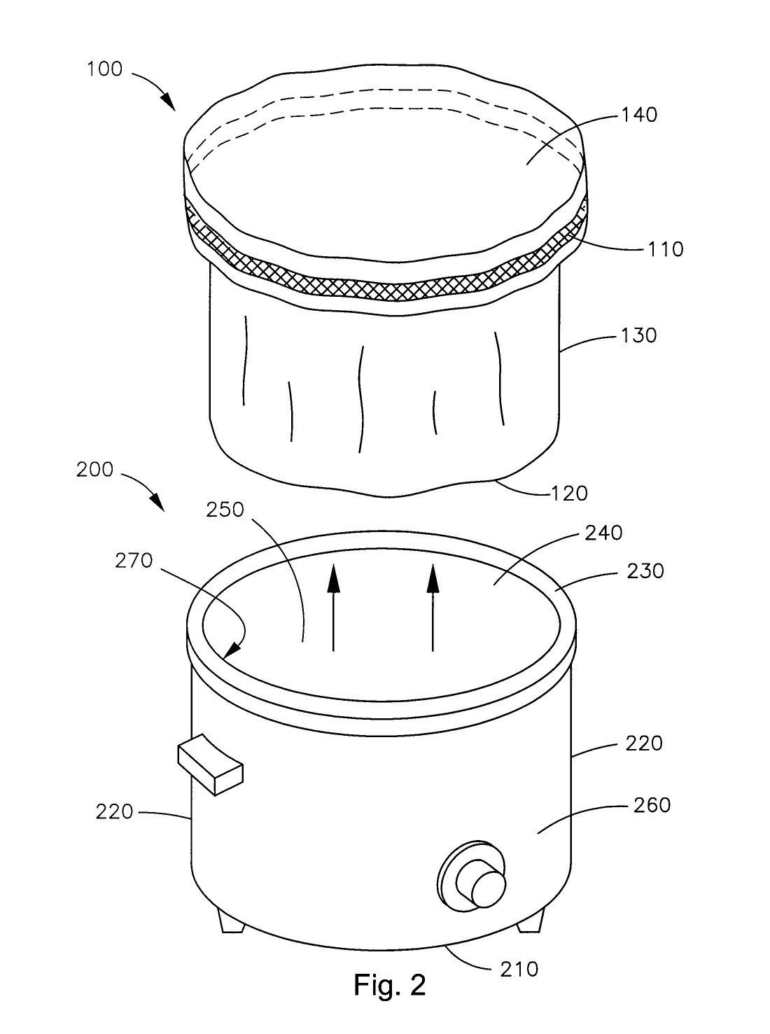

FIGS. 1-11B depict exemplary slow cooker liners in accordance with embodiments of the present invention. As shown, the slow cooker liner system 100 may be placed within a cooking apparatus 200, such as a slow cooker, in order to form a barrier between the slow cooker and food being cooked/heated in the slow cooker. As shown, an exemplary slow cooker 200 may include a bottom 210, one or more side walls 220 extending upward from the bottom 210 to a rim or lip 230 that forms a top opening 240 of the slow cooker. The bottom 210, side wall(s) 220 and rim 230 of the slow cooker define a container or bowl 250 in which food may be placed to be cooked.

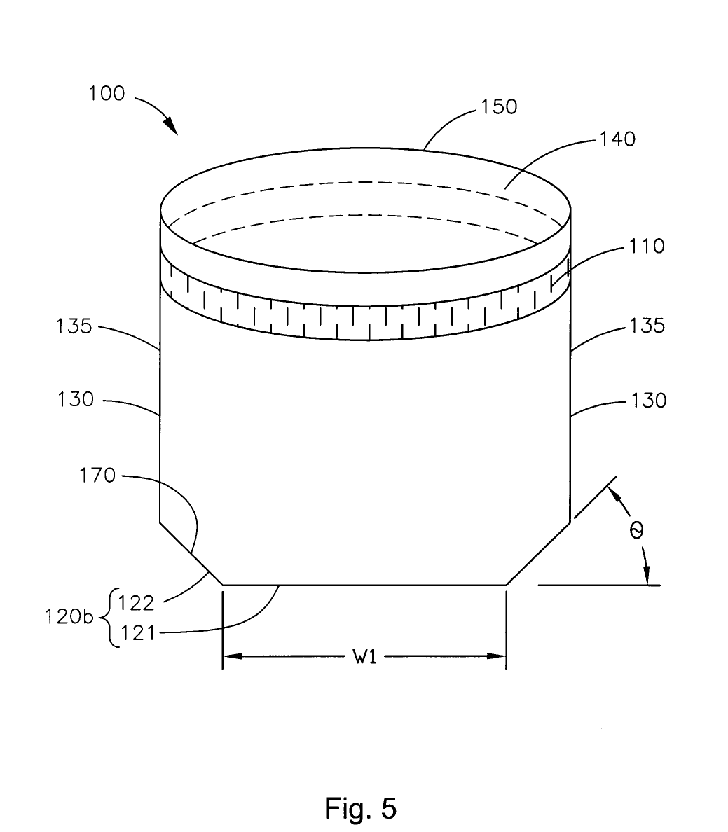

As shown, the slow cooker liner system 100 may include a liner having a securing band 110 about the open top end 140 that helps form and maintain an improved barrier between the slow cooker and food which may be disposed within the slow cooker. The exemplary securing band shown in FIGS. 1-4 includes an elastic securing band 110a. The exemplary securing band shown in FIGS. 5-7 includes a heat shrink securing band 110b.

As shown in FIGS. 1-11B, an exemplary slow cooker liner 100 may include a preformed substantially tubular, or bag-like, shaped body. The liner body may include a closed bottom end 120, one or more upwardly extending side walls 130 and an open top end 140. In use, the closed bottom end 120 of the liner is disposed over an interior surface 265 of the bottom 210 of the slow cooker and the side wall(s) 130 of the liner are disposed over an interior surface 270 of the side wall(s) 220 of the slow cooker.

A high temperature securing band 110 may be incorporated around a perimeter of the open top end of the liner 140. The securing band 110 may be located at the distal end of the liner around the peripheral of the open top end 140, or may be located proximate the open top end 140 in an upper portion of the liner and around the periphery of the open top end 140. The securing band 110 may be attached to an inside surface of the liner and/or an outside surface of the liner.

The one or more flexible side walls 130 may extend upwardly from the bottom edge 120, and a top opening 140 may be formed at the opposite top end by a top edge 150 of each of the side walls 130. The closed bottom end 120 may be folded or sealed closed. The one or more side walls 130 may be connected together, preferably along one or more folded or sealed edges 135.

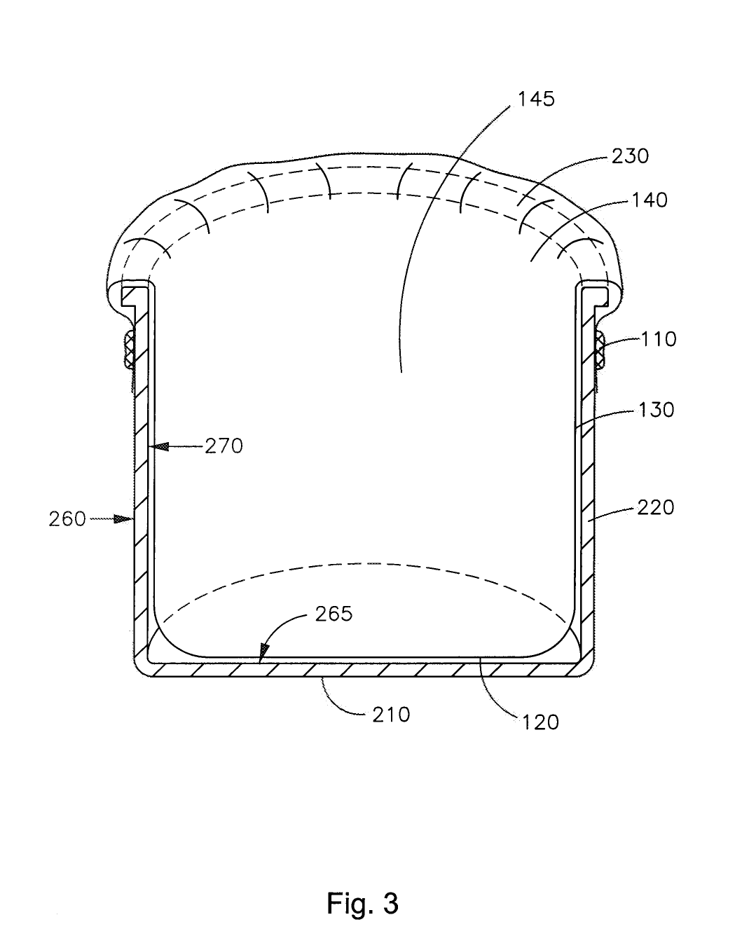

The closed bottom edge 120 and the upwardly extending side walls 130 may define a food holding vessel 145 capable of fitting within a slow cooker container and holding a volume of food that may be disposed therein for heating or cooking. Preferably, the liner 100 is generously sized to afford complete coverage of the slow cooker 200 and allows an excess portion of the liner proximate the top end to be folded outwardly over the top edge and rim 230 of the slow cooker. The securing band 110 may then contract thereby holding the excess portion of the liner to an exterior surface 260 of the slow cooker, as best shown in FIGS. 1 and 3.

Although some forming may occur once the liner has been disposed within the container of the slow cooker, such as moisture adhesion and thermal-forming as the slow cooker is heated, the liner may be preformed having a closed bottom end 120 and upwardly extending sidewalls 130 which may define the food holding vessel 145 which may be sized and shaped to fit within and cover the interior surface 265/270 of the container of the slow cooker 200. In addition, the weight of the food may also exert some pressure on the liner which also helps to further form the liner to the slow cooker.

FIGS. 1-4 show an exemplary slow cooker liner 100 having an elastic securing band 110. As shown in FIGS. 1-4, a high temperature elastic securing band may be incorporated around the perimeter of the opening of the liner 140. The high temperature elastic band 110 may be made from a high temperature elastic polymer, such as a polyester elastomer, for example. The band may also be made from other materials such as an elastomeric polyamide based film or resin or a polyurethane material, for example. Example polyester elastomers include: RKX-230, RKX-227, and RKX-233, which as manufactured by Ticona® and which have different elongations and melt points. An example elastomeric polyamide includes PEBAX® made by ARKEMA®.

Table of exemplary elongations and melting points:

| Material | Elongation | Melting Point |
|---|---|---|
| RKX-230 (Ticona) ® | 440% | 350° F. |
| RKX-227 (Ticona) ® | 350% | 350° F. |
| RKX-233 (Ticona) ® | 240% | 403° F. |

The elastic securing band 110 may be attached to the perimeter of the liner. For example, the elastic securing band 110 may be attached to the perimeter of the liner using a high temperature adhesive. Alternatively, the elastic securing band 110 may be attached to the perimeter of the liner by ultrasonically welding the securing band to the liner. In another embodiment, the elastic securing band 110 may be stitched to the liner material using a high temperature thread. In yet another embodiments, the elastic securing band 110 may be heat sealed to the liner.

FIGS. 5-7 show another embodiment of the securing band 110. As shown in FIGS. 5-7, the securing band 110 may include a heat shrink securing band 110. A heat shrink securing band 110 may include a material(s) that has(have) heat shrink properties. For example, a polyester film—such as MQ501, made by M & Q Plastics—may be ultrasonically welded to the perimeter of a polyester based liner. When the slow cooker 200 is turned on and heats the liner material, the shrink polyester film may shrink around the perimeter of the slow cooker and may snag up the excess material around the perimeter of the liner.

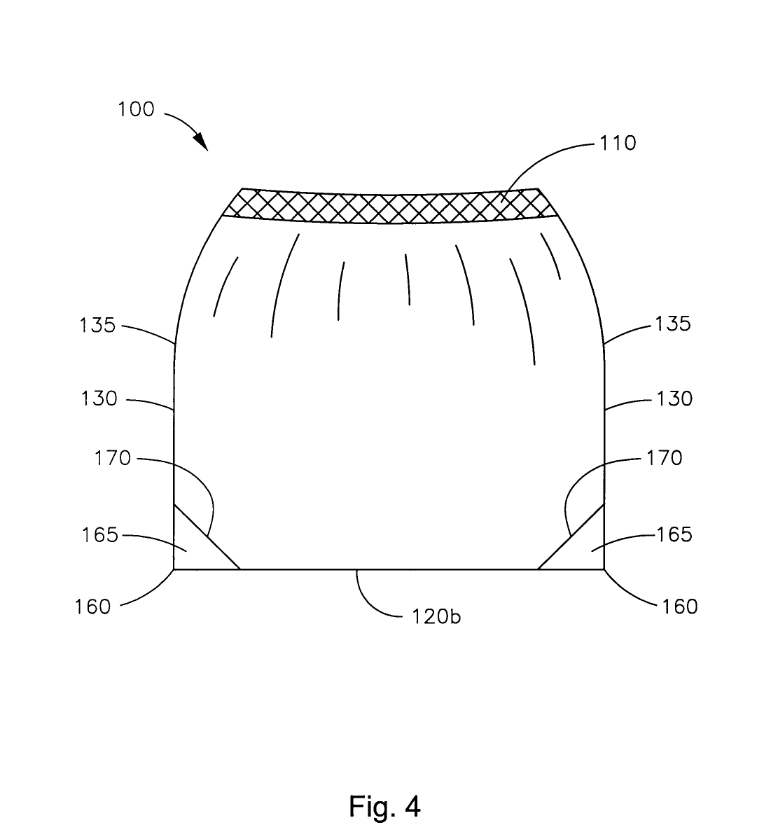

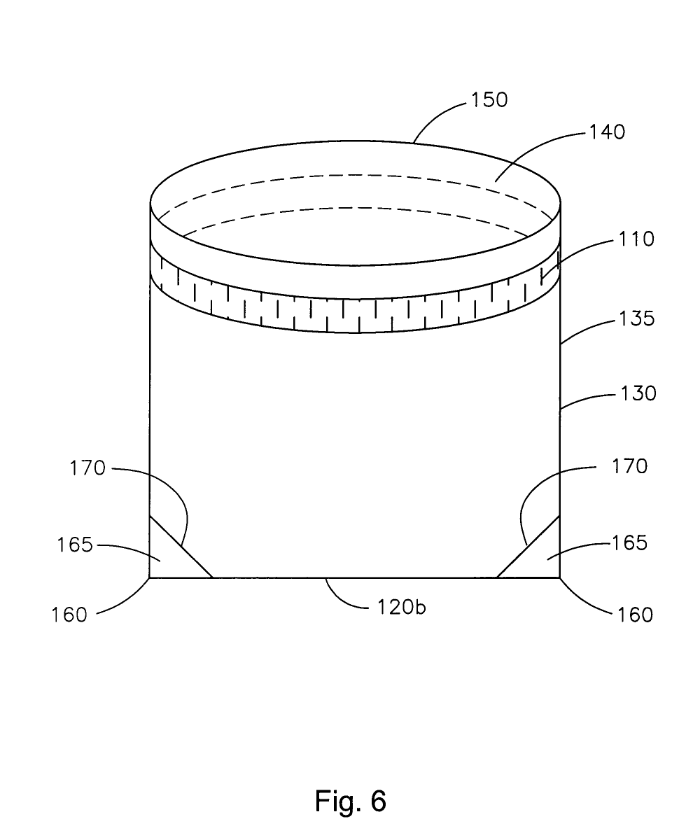

As shown in FIGS. 4-7, the closed bottom end 120 of the liner may be formed having a contoured or shaped bottom edge 120b. The contoured bottom edge 120b may eliminate, close or seal off the dog ears or tails 165 that are typical of conventional slow cooker liners proximate the corner areas 160 formed between the bottom edge 120 and the side walls 130. The dog ears or tails 165 of the liner may be eliminated by either sealing or bonding 170 the side walls 130 together, as shown, thereby closing off the dog ear portion 165 of the liner. The unused (e.g., closed off) material of the dog ear 165 can be left in place on the liner (as shown in FIGS. 4 and 6), or the unused material may be removed at some time prior to using the liner (e.g., FIG. 5 shows the dog ears removed).

FIG. 5 shows the bottom contoured edge 120b having a flat bottom edge 121 and one or more contoured or shaped edges 122, wherein the contoured edges 122 include one or more tapered, or sloped, edges. Each tapered edge may extend outward and upward from the flat bottom edge 121 and may join and merge an opposite end of the flat bottom edge 121 with one or more of the side wall sealed edges 135. The tapered edges may form an angle θ with a bottom plane.

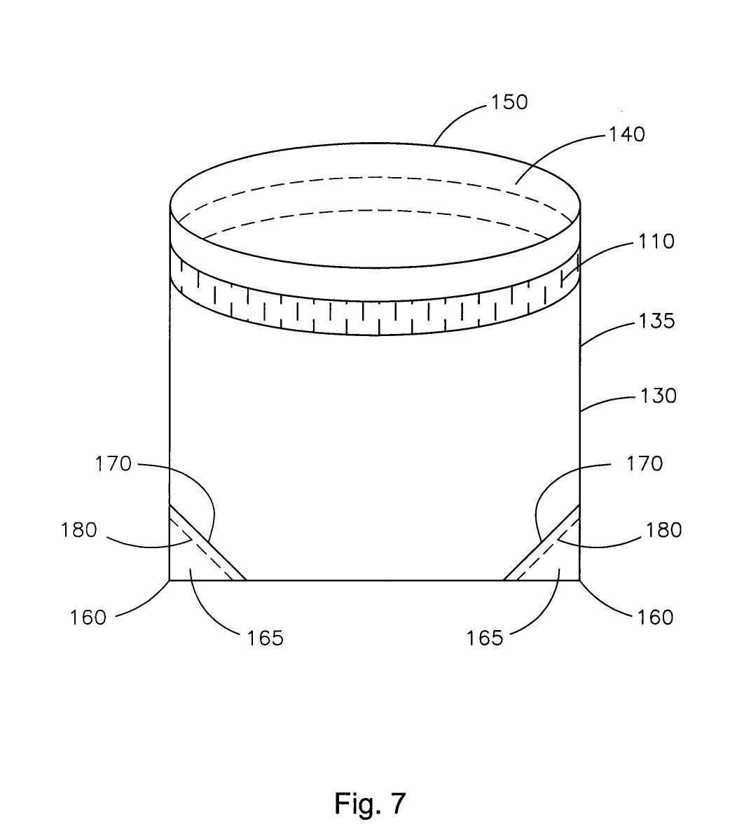

As shown in FIG. 7, the liner 100 may include a perforation 180 formed parallel along each of the sealed contoured edges 170 on the dog ear 165 side of the sealed contoured edge 170. The perforated edge 180 may be made using a cutting device to make a plurality of serially aligned cuts, or slots in a line that is substantially parallel to the contoured edge 170 and the dog ear 165 side of the contoured edge 170. These perforations 180 allow the dog ears 165 to be easily removed either after the manufacturing process or just prior to use.

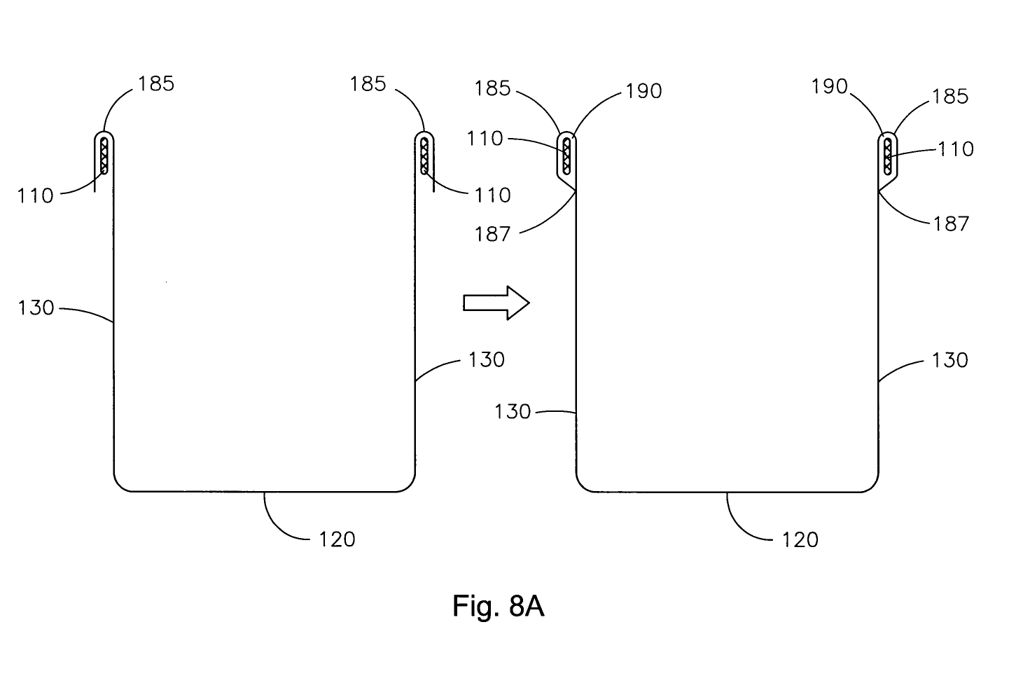

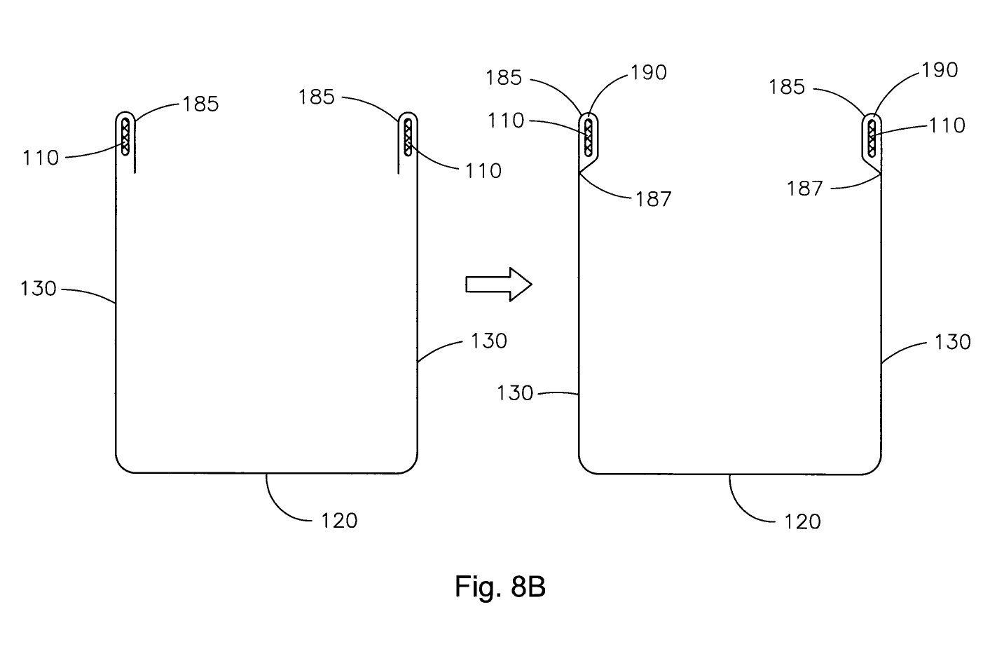

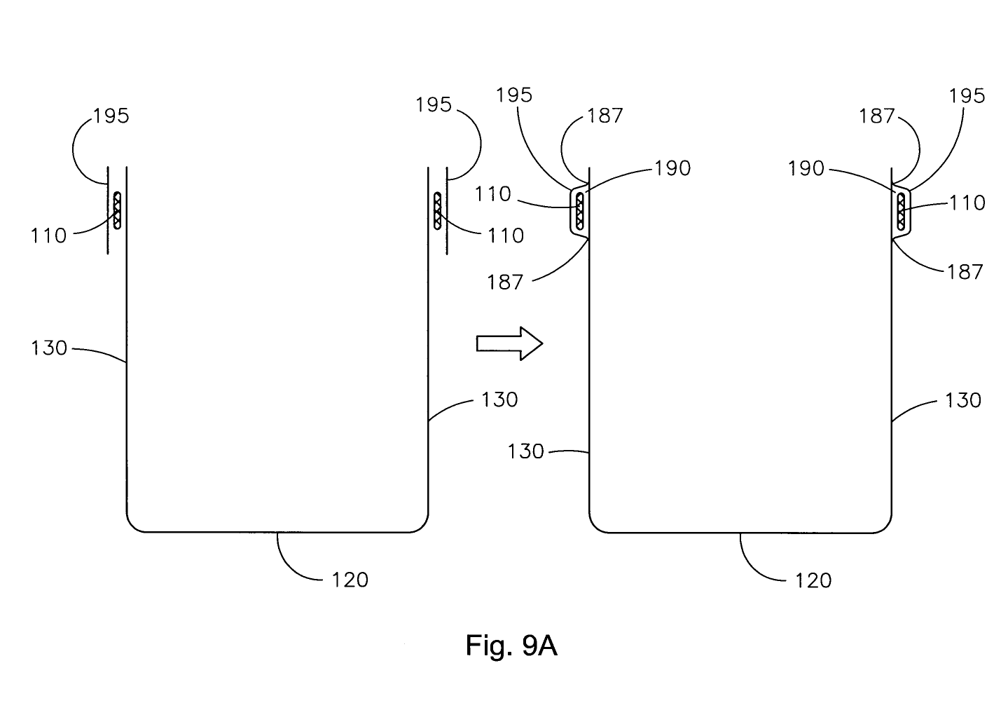

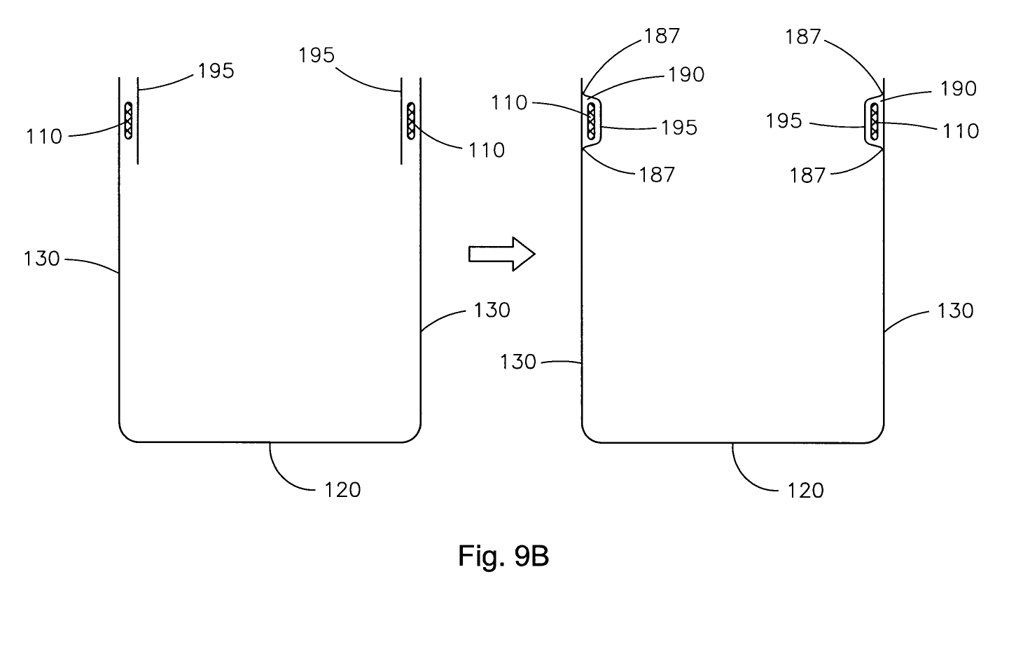

In some embodiments, the securing band 110 may be enclosed within the one or more sidewalls as seen in FIGS. 8A-11B. For example, the liner material may be folded 185 outwardly (FIG. 8A) or inwardly (FIG. 8B) proximate to the side wall 130 to cover the securing band 110. The folded portion 185 may then be attached 187 to the securing band 110 and/or the sidewall 130 to encapsulate the securing band 110 within a cavity 190. In another embodiment, a separate liner strip 195 may be placed over the securing band 110 wherein the securing band 110 is outside of the sidewall 130 (FIG. 9A) or inside of the side wall 130 (FIG. 9B). The liner strip 195 may then be attached 187 to the securing band 110 and/or the side wall 130 to encapsulate the securing band 110 within a cavity 190.

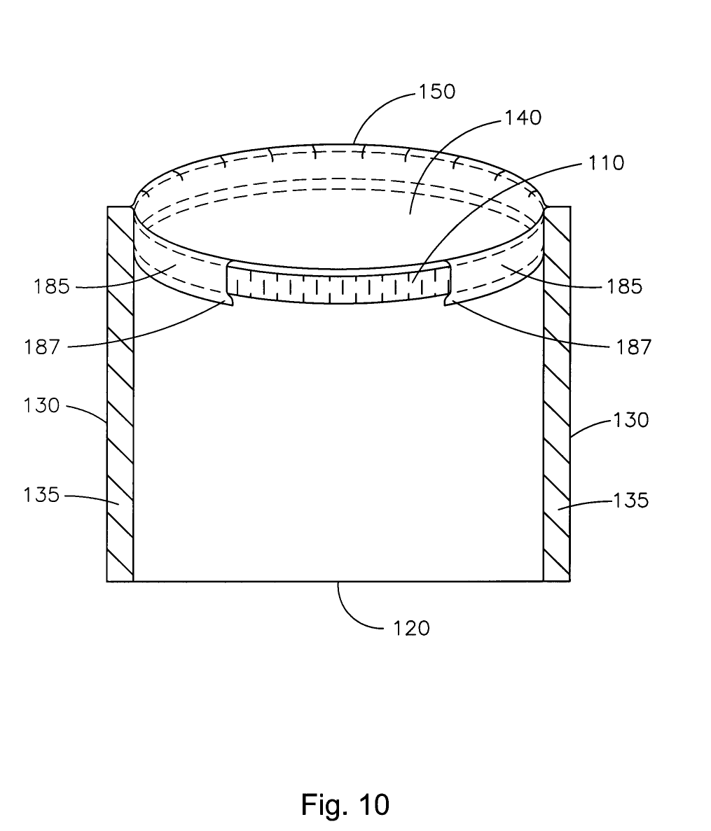

FIG. 10 shows the front view of a liner system 100 wherein the securing band 110 is enclosed within a liner side wall 130. In this embodiment, the folded 185 over side wall 130 or liner strip 195 was sealed to the side wall 130 rather than the securing band 110. The securing band 110 may be sealed to the side wall 130 by a seal extending along the length of the lining system. The resulting liner system comprises a securing band 110 that is not adhered to the liner along its length, but is adhered to the liner at its ends and forming a securing band 110 around the perimeter of the liner system 100.

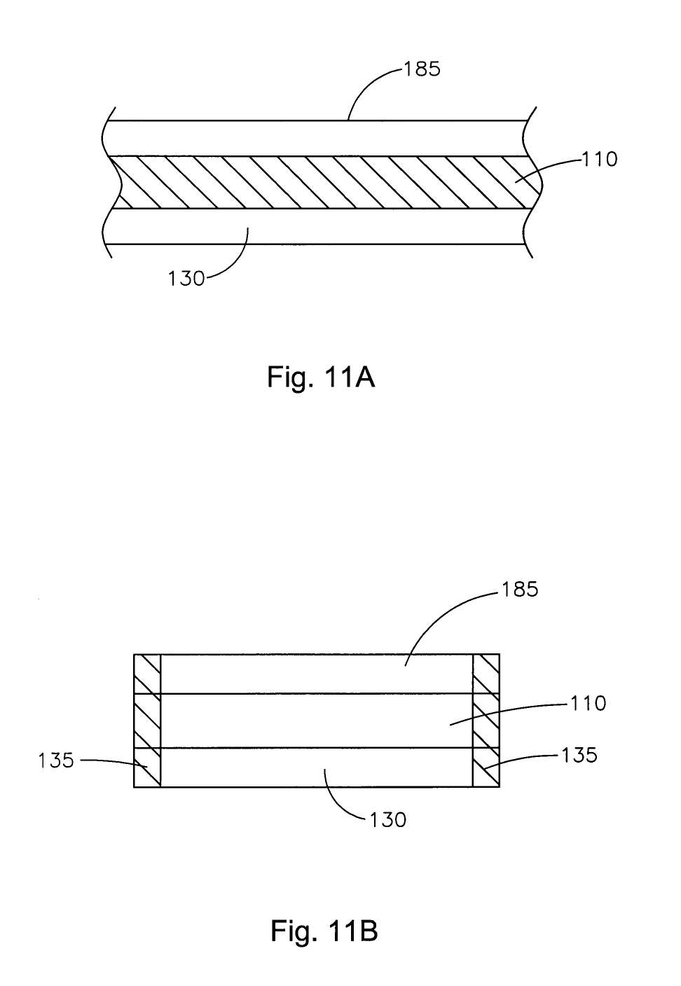

In certain embodiments, the folded portion 185 or liner strip 195 may be attached to the securing band 110 and the sidewall 130 along the length of the securing band 110 (FIG. 11A). In other embodiments, the folded portion 185 or liner strip 195 may attached only to the side wall 130, not the securing band 110. In this embodiment, the unattached elastic securing band may relax to its original length within the cavity 190, reducing the effectiveness of the securing band. To alleviate this problem, the ends of the securing band 110 may be sealed to the side walls 130 to form the sealed edge 135 (FIG. 11B). When the securing band relaxes, it is attached to the side wall and forms a continuous securing band around the entire perimeter of the liner system 100.

There may be several benefits to enclosing the securing band within the side wall. For example, an enclosed securing band may be less likely to come into contact with a food product. This is of significance if the securing band material is not approved by the United States Food and Drug Administration for contact with food. Enclosing such a non FDA-approved securing band material within a liner material that is FDA-approved for food contact is desirable. Further, if the securing band is comprised of an elastomeric material, such material may become tacky at increased temperatures and stick to the outside of a slow cooker. Enclosing the securing band within the side walls prevents this from occurring. Also, enclosing the securing band within the side walls may provide for a more secure mechanism for adhering the securing band to the liner.

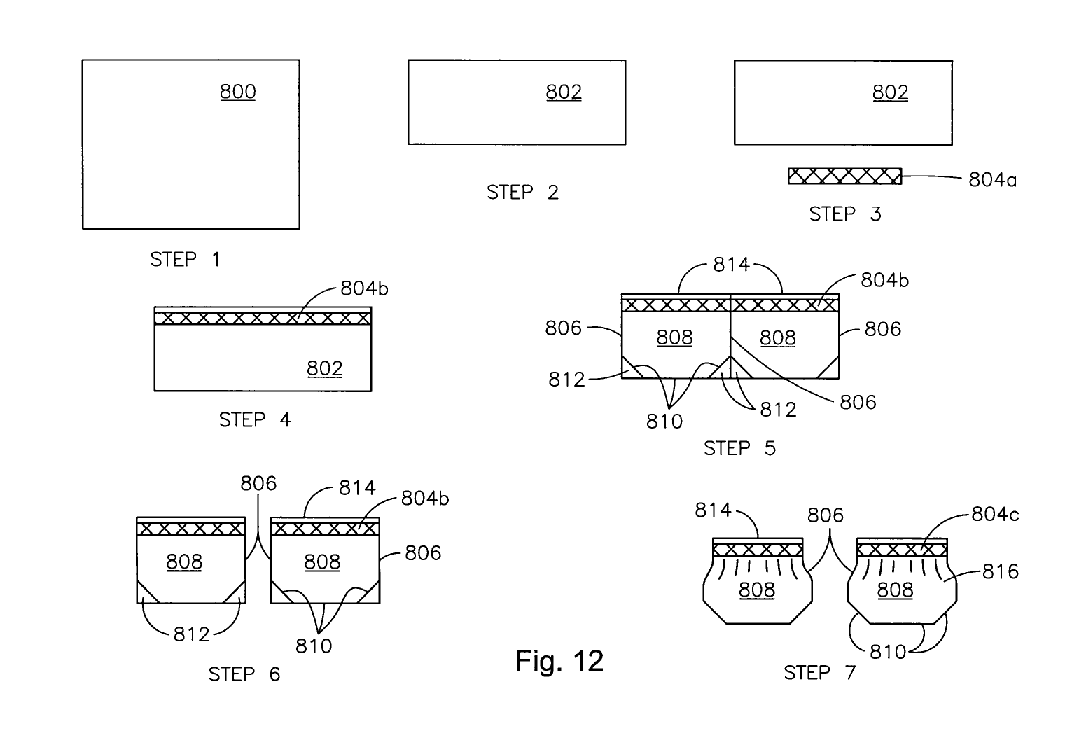

FIG. 12 illustrates an exemplary method of manufacturing a slow cooker liner having an elastic securing band. As shown in FIG. 12, the bag-shaped liner may be manufactured from a sheet of liner material 800—Step 1. The liner material may be folded over along, for example, it longitudinal length to form a folded sheet of liner material 802—Step 2. At Step 3, the folded liner material 802 is shown in perspective to an elastomer material 804a that may be used as the securing band material. The elastic material 804a shown in Step 3 is in an unstretched (i.e., no tension) state and has a length that is shorter than the length of the liner substrate.

At Step 4, the elastic material 804b is stretched to have a length that corresponds to the length of the folded liner material 802. The elastic material 804b may then be attached to the liner material 802b while the liner substrate is still in sheet form. The attachment of the elastic material 804b to the liner material 802 may be accomplished using a high temperature adhesive to adhere the elastic material to the liner material, by ultrasonic welding the elastic material and the liner material together, and/or by heat sealing the elastic material onto the liner material.

A sealing device (not shown) may be used at Step 5 to seal one or more side edges 806 thereby forming individual slow cooker liners 808. If the slow cooker liner includes a contoured bottom edge, then the contoured bottom edge 810 may also be formed by the sealing device during Step 5. Unused portions (i.e., dog ears) 812 of the liner material are sealed off during the forming of the contoured bottom edge 810.

As such, in the illustrated embodiment a closed bottom of the liner is formed from the folding of the liner material, portions of the contoured bottom edge and closed side edges are formed from the heat sealing of the liner material. The slow cooker liner includes an open top end 814. Adjacent slow cooker liners may be separated from one another using a cutting device (not shown) that may cut down the center of a sealed edge or cut between adjacent sealed edges—Step 6.

Step 7 shows the individual slow cooker liners having an elastic securing band wherein the elastic securing band is not stretched (i.e., no tension). As shown, the elastic material of the securing band gathers up when the elastic material is not longer being stretched. As the elastic material gathers up, it forms pleated portions 816 in the top portion of the slow cooker liners. The unused portions (i.e., dog ears) 812 may be left in place or may be removed, such as shown in Step 7 of FIG. 8.

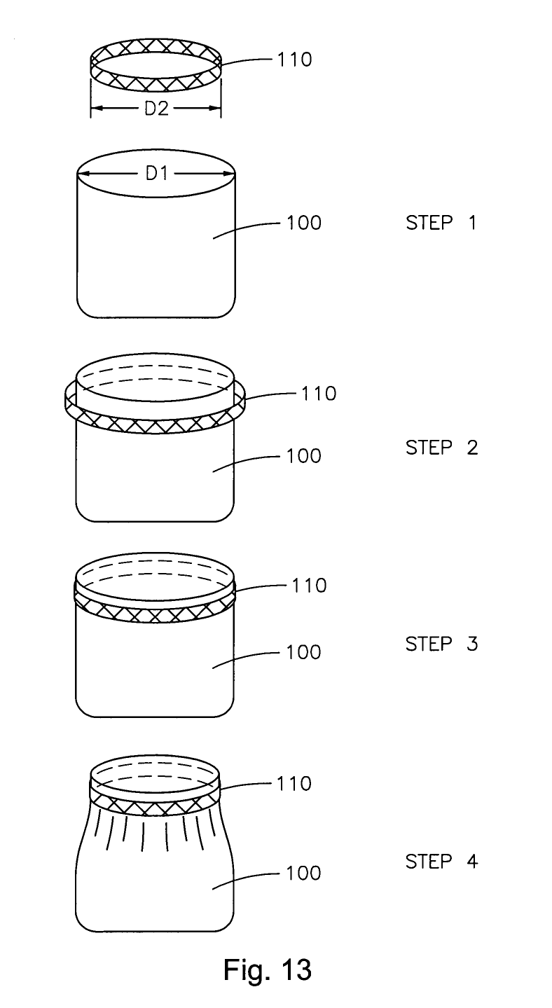

FIG. 13 illustrates another exemplary method of manufacturing a slow cooker liner having an elastic securing band. Step 1 of FIG. 13 shows the liner 100 and the elastic securing band 110 in an unstressed state. In one preferred method of manufacturing the slow cooker liner and for attaching the elastic securing band to the liner includes elongating and stretching the elastic securing band so that it can fit over and around the top portion of the liner proximate the top opening—Step 2. Stretching of the elastic material—and hence tension on the elastic band—may then be release until the elastic securing band comes into contact with the outside of the liner. The elastic band may then be attached to the liner—Step 3. As such, the elastic securing band is attached to the liner in a condition wherein the elastic band is elongated or stretched, but the liner is not folded or pushed inward. Once the elastic securing band is attached to the liner, then stretching of the elastic materials—and hence tension on the elastic securing band—may be completely released—Step 4. This causes the elastic securing band to gather back up and causes the top portion of the liner to also contract and move inward thus forming pleated surfaces in the top portion of the liner around the perimeter of the liner.

Accordingly, as shown in FIG. 13, the top opening of the slow cooker liner may have a diameter or width D1 and the elastic securing band may have a diameter or width D2. During the unstressed state (Step 1) of the exemplary process for attaching the elastic securing band to the liner, the liner opening D1 is greater than the elastic band opening D2. During Step 2, the elastic material is stretched until its opening D2 is greater than the liner opening D1. This allows the elastic securing band to be placed over the liner opening and around the perimeter of the liner proximate the top opening. During Step 3, the tension (i.e., stretching) of the elastic material may be released until the point where the elastic securing band contact the liner. At this point, the elastic securing band may be attached to the liner. The securing band may be attached using a high temperature adhesive, by heat or thermal sealing, by ultrasonic welding of the two materials, and the like. Once the securing band is attached to the liner, all tension (i.e., stretching) of the elastic material may be released (Step 4). As shown, pleats may form as a result of the elastic material gathering up once the tension is released (see e.g., FIG. 4).

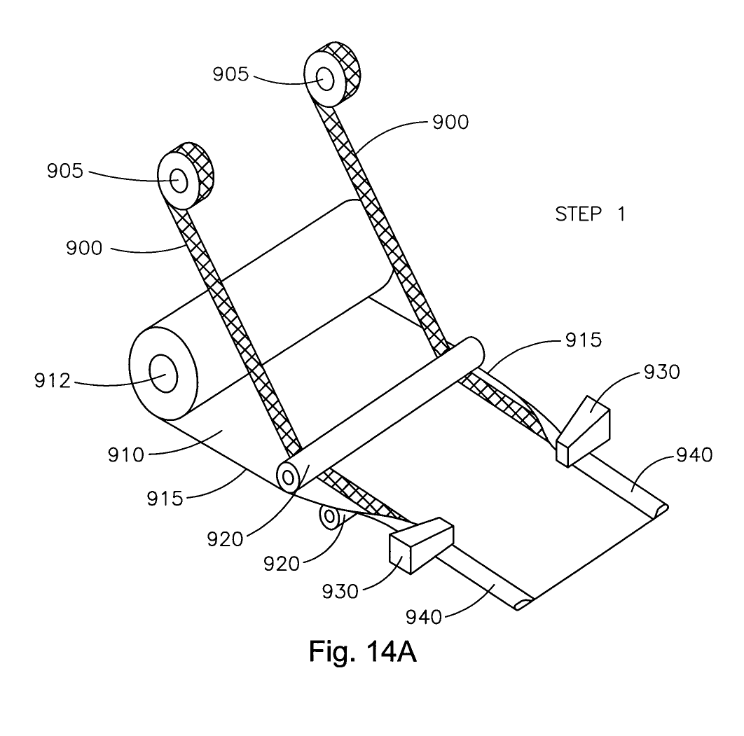

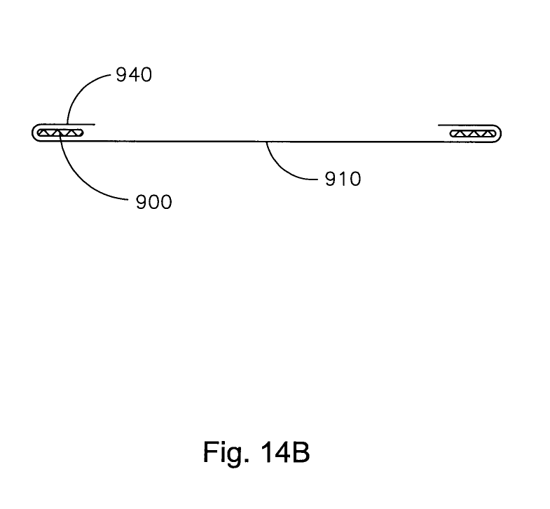

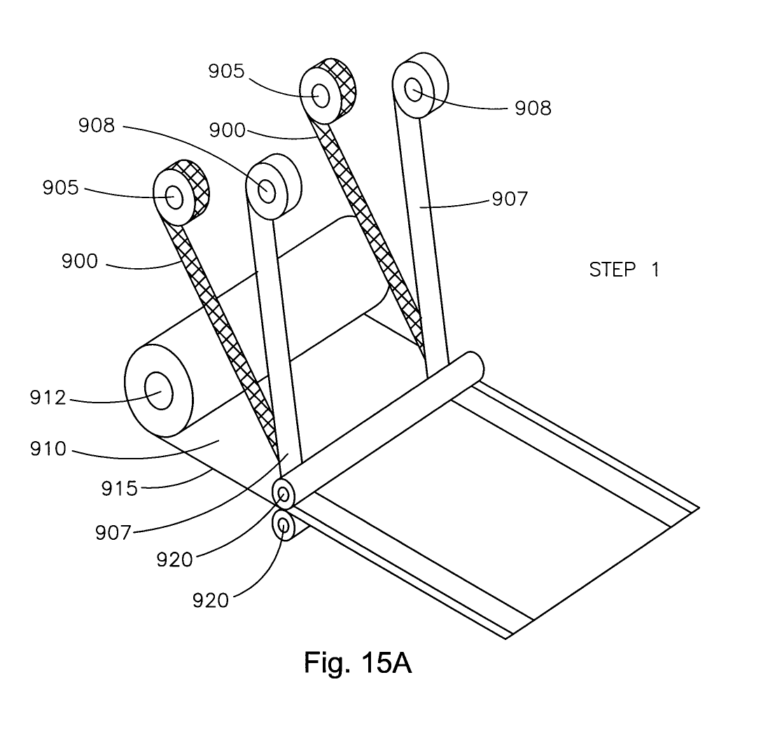

FIGS. 14A-19 illustrate additional exemplary methods of manufacturing a slow cooker liner having an elastic securing band. As shown in Step 1 of FIG. 14A, two spools 905 of elastic band 900 may be provided under tension and proximate each end 915 of a liner sheet 910 on a spool 912. The liner sheet 910 and elastic bands 900 may be pulled through rollers 920 and the ends 915 of the liner and elastic bands 900 may pass through curling fixtures 930 to fold the liner ends 915 over the elastic bands 900 forming a folded edge 940. A cross section of the liner sheet 910 with folded edges 940 over elastic bands 900 can be seen in FIG. 14B.

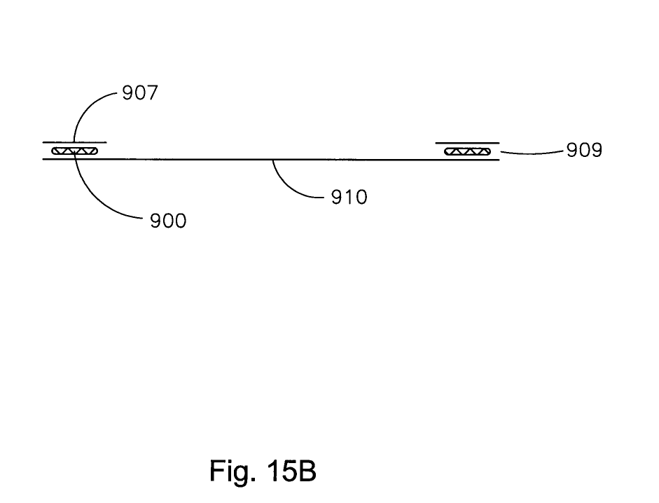

Alternatively, as shown in FIG. 15A, the elastic securing band 900 may be covered with a nylon liner strip 907 on a spool 908 to form a covered edge 909. In this embodiments, no curling fixture is needed to fold the ends 915 of the liner sheet 910 to form a folded edge 940. A cross section of the liner sheet 910 with the liner strip 907 over elastic bands 900 can be seen in FIG. 15B.

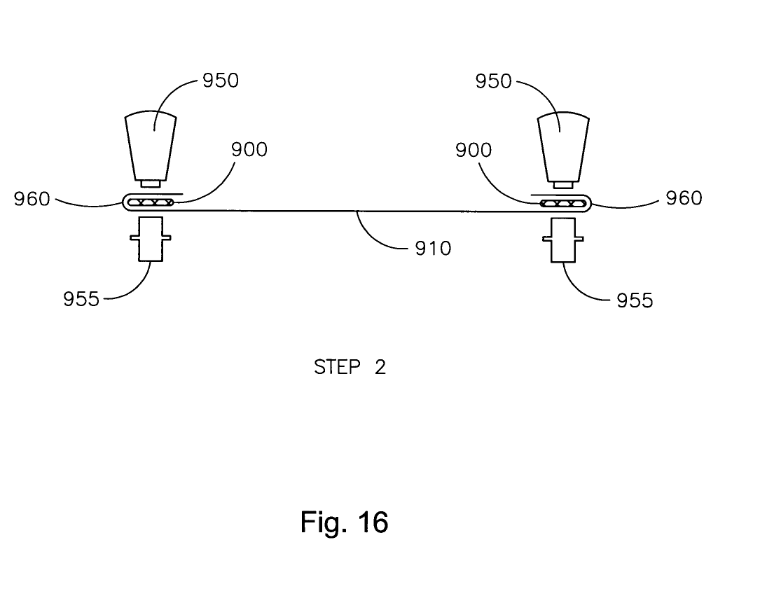

As shown in FIG. 16, the folded edges 940 and/or covered edges 909 may be attached to the liner 910. For example, with the elastic bands 900 still under tension, the folded edges 940 or covered edges 909 may be ultrasonically sealed by passing each folded edge 940 or covered edge 909 under an ultrasonic horn 950 and over a knurled anvil wheel 955 forming a sealed edge 960—Step 2 (FIG. 16). Methods to seal the folded edges 940 or covered edges 909 are not limited to ultrasonic sealing. Other methods may include heat sealing, stitching, high temperature adhesive, etc.

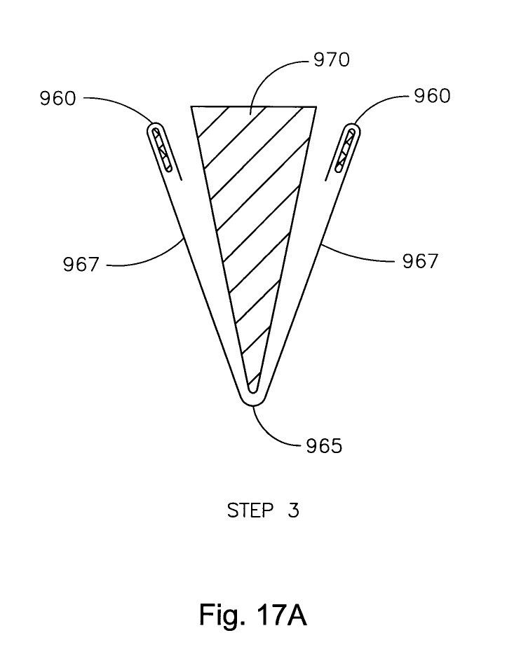

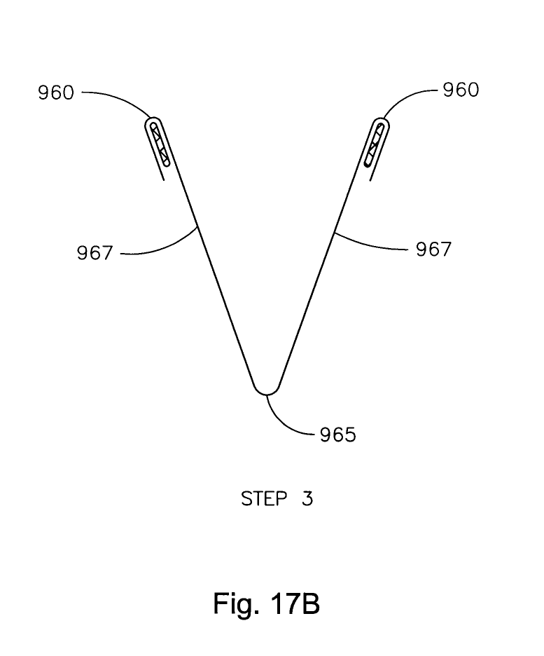

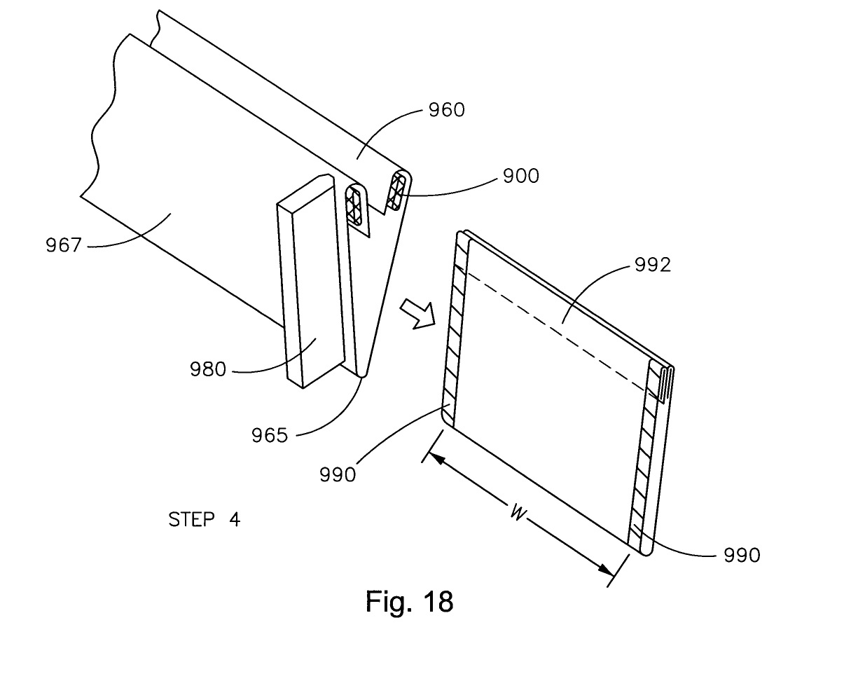

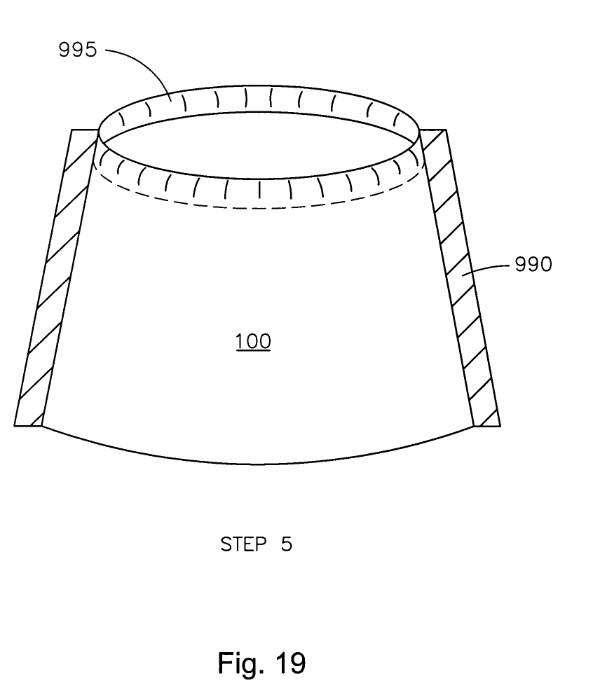

Following closing/sealing of the edges, Step 3 comprises folding the liner sheet 910 down its center 965 by passing the liner sheet along an A frame device 970 to form two side potions 967. The A frame device 970 may be applied to the liner sheet so that the sealed edges 960 are internal to the liner sheet 910 (FIG. 17A) or external to the liner sheet 910 (FIG. 17B). Following folding, the side portions 967 may be heat sealed 990 by a heat seal bar 980 from the center 965 to the sealed edges 960 (FIG. 18). The side portions 967 may be heat sealed at various intervals with a width W suitable for one side 992 of a slow cook liner. After the side has been sealed 990, the slow cook liner may be formed by cutting the sides of the liner along the heat seal 990 with the elastic bands still under tension. Once the sides are cut, the elastic bands return to their unstretched state forming the liner 100 (FIG. 19).

The liner may include a variety of shapes and sizes. Preferably, the shape and size of the liner will correspond to the shape and the size of the slow cooker container that the liner will be used with. In another embodiment, the slow cooker liner may include a shaped bottom edge that corresponds to the shape of the bottom of the slow cooker container. For example, if the slow cooker container has a rectangular-shaped bottom, the slow cooker liner would have a corresponding rectangular-shaped bottom, if the slow cooker container has a square-shaped bottom, the slow cooker liner would have a corresponding square-shaped bottom, if the slow cooker container has an oval-shaped bottom, the slow cooker liner would have a corresponding oval-shaped bottom, etc.

The liner material may be suitable for continuous service under various conditions and may have the following characteristics: suitable for temperature conditions ranging from about 100° F. to about 400° F.; has a good thermal heat transfer rate; has a tensile strength capable of withstanding approximately 13,000 psi without orientation; has a tear strength capable of holding up to about 50 grams/liter; has a tabor strength capable of sustaining about 1000 cycles tested with a load of about 500 grams; has a chemical resistance to most chemicals, such as mineral acids, phenols and concentrated formic acid; has a bacterial and mold resistance making it rot proof and resistant to molds and impermeable to micro-organisms; acts as an odor barrier to most odors; has a grease and oil resistance having an oil-barrier properties effective against animal, vegetable, and mineral oils and fats; allows some moisture-vapor transmission at raised temperatures; is gas impermeable which makes the liner well suited for packaging under nitrogen, carbon dioxide, or vacuum, and is resistant to oxygen permeation which reduces fogging in frozen foods and may help extend shelf-life; is non-scalping (e.g., no flavor loss); and will not block (e.g., will not stick together).

In certain embodiments, the liner material may provide oil and grease resistance and may be manufactured from resins that meet all requirements of the United Sates Food and Drug Administration regulations 21 CFR 177.1500 (a)(1)(6), (b)(1)(6.1) and 21 CFR 178.2010 to produce articles intended for use in the processing, handling and packaging of food products. In addition, embodiments of the liner material may have the following properties as listed in Table 1.

| Properties | Values |
|---|---|
| Thickness | .75 to 3 mils |
| Area Yield | 27,240 in²/lb |
| Haze | 10.4 to 12.6% |
| Gloss, 20 Degree | 51.3 to 61.8 |
| Tensile Strength | 15,000 to 19,000 psi |
| Elongation | 315 to 400% |
| Tear | 470 to 540 grams/mil |
| Puncture Strength | 340 to 470 grams |
| Coefficient of Friction (film-film, Kinetic) | 0.20 to 0.45 |
| Coefficient of Friction (film-metal, Kinetic) | 0.30 to 0.45 |
| Oxygen Transmission Rates (cc/100 in²/day): | |
| 0% R.H., 73° F. | 2.80 |
| 50% R.H., 73° F. | 1.90 |
| 90% R.H., 73° F. | 4.40 |
| 100% R.H., 73° F. | 11.5 |
| Water Vapor Transmission Rate | |
| (grams/100 in²/day): | |
| 100% R.H., 100° F. | 32.0 |

The liner may be made from a durable and high temperature plastic material or nylon film, such as a nylon resin. For example, the liner may be made from a high temperature nylon or polyester, such as a material from the polyamide family including nylon 3, 4, 6, 9, 11, 12, and triple nylons. An exemplary nylon resin material that is suitable for use with the present invention may include MONOLYN™ material manufactured by M&Q Plastic Products. The thickness of the liner may range between 0.8 mils and 1.0 mils.

In yet another embodiment, the entire liner and/or part of the liner may be made out of high temperature elastic films like polyester elastomer or PEBAX® (i.e., a polyamide elastomer), so that it fits snuggly about the vessel, with no excess bag for food to get trapped in. In this embodiment, the bag-shaped liner would stretch around the rim or lip of the slow cooker to improve the cooking process and provide a nice, neat appearance.

In another embodiment, the entire liner and/or part of the liner may be made out of a thin, high temperature clingy film, similar to Saran wrap, so that it clings snugly around the surface area of the container. This design and construction would improve the aesthetic appearance and performance of the liner and would again eliminate excess bag for food to get trapped in.

In another embodiment of the invention, a thin walled vessel may be thermoform out of nylon or some other high temperature thermo formable plastic, instead of creating a bag to line the slow cooker. This thermoformed vessel would slide down inside the slow cooker container to act a barrier between the interior surfaces of the slow cooker and the food contained therein.

The thermoformed vessel may also fit snuggly so that food cannot get trapped. The thermoformed vessel may be sized so that it will not extend beyond the top of the slow cooker liner container, so that there is no excess liner material to worry about. Also, the thermoformed vessel liner could be fluted, to help control heat transfer between the slow cooker wall and the liner, and hence prevent burning of the food. These thermoformed vessel liners may “nest together”—like paper coffee filters or paper cup cake liners—when being stored prior to use.

The improved liner may be a removable, replaceable, flexible, disposable, durable, high temperature, plastic liner that may be disposed within a container of a slow cooker to cover the interior surfaces of the container. The liner may be provided to keep food separate from the interior surface of the container thereby prevent food contained within the slow cooker container from “baking-on” and/or “burning-on” the surfaces of the slow cooker. Embodiments of the slow cooker liner may also help improve food safety and quality, enhance flavor and juiciness of foods, minimize clean up time, and reduce shrinkage by allowing left over food to be removed from the slow cooker and saved in the liner for further use.

Although illustrated and described herein with reference to certain specific embodiments, it will be understood by those skilled in the art that the invention is not limited to the embodiments specifically disclosed herein. Those skilled in the art also will appreciate that many other variations for the specific embodiments described herein are intended to be within the scope of the invention as defined by the following claims.

1. A method for making a disposable slow cooker lining system to cover the interior surface of a slow cooker comprising:
forming a generally tubular, or bag-like shaped liner comprising:
a closed bottom end,
one or more side walls extending upwardly from the closed bottom end, and
an open top end; and
adhering a securing band to the liner proximate the open top end of the liner.

2. The method of claim 1 further comprising forming the closed bottom end of the liner by folding a sheet of liner material along its longitudinal length to form a folded liner sheet.

3. The method of claim 1 further comprising forming one or more side walls by sealing one or more edges of a sheet of liner material.

4. The method of claim 3 further comprising ultrasonically welding the one or more edges.

5. The method of claim 3 further comprising heat sealing the one or more edges.

6. The method of claim 3 wherein the securing band is an elastic securing band.

7. The method of claim 6 further comprising stretching the elastic securing band prior adhering to the liner.

8. The method of claim 1 further comprising adhering the securing band to the liner using a high temperature adhesive.

9. The method of claim 1 further comprising adhering the securing band to the liner by ultrasonically welding the securing band to the liner.

10. The method of claim 1 further comprising adhering the securing band to the liner by heat sealing the securing band to the liner.

11. The method of claim 1 further comprising adhering the securing band to the liner by stitching the securing band to the liner with high temperature thread.

12. The method of claim 1 further comprising forming a contoured bottom edge at the closed bottom end.

13. The method of claim 11 further comprising forming the contoured bottom edge having a flat bottom end and one or more contoured edges formed between the flat bottom edge and one or more of the side walls.

14. The method of claim 12 further comprising extending the one or more contoured edges outward and upward from an opposite end of the flat bottom edge and merge to join with the one or more side walls.

15. The method of claim 12 wherein the one or more contoured edges merge and join at its opposite end with an edge of the side walls.

16. The method of claim 1 further comprising enclosing the securing band within the one or more side wall.

17. The method of claim 16 further comprising folding one or more of the edges of the liner sheet over the securing band to enclose the securing band within the one or more side walls.

18. The method of claim 16 further comprising placing a liner strip over the securing band to enclose the securing band between the one or more side walls.

19. The method of claim 1 wherein the slow cooker lining system can withstand temperatures of up to about 400° F.

20. A method for making a disposable slow cooker lining system to cover the interior surface of a slow cooking apparatus comprising:
providing a sheet of liner material;
placing an elongated elastic band onto the sheet of liner material proximate to each edge of the sheet of liner material;
enclosing the elastic band within the liner material;
attaching the elastic band to the liner material;
folding the sheet of liner material along its longitudinal length to form a closed bottom end and an open top end; and
sealing the edges of the sheet of liner material to form one or more side walls extending between the closed bottom end and the open top end.

21. The method of claim 20 further comprising cutting the sheet of liner material at the heat sealed edges to form a generally tubular, or bag-like shaped structure.

22. The method of claim 20 further comprising enclosing the elongated elastic band within the liner material by folding the edges of the sheet of liner material over the securing band and attaching the distal end to the sheet of liner material.

23. The method of claim 22 further comprising attached the securing band to the edges of the sheet of liner material.

24. The method of claim 20 further comprising enclosing the elongated elastic band within the liner material by placing a liner strip over the securing band and attaching the edges of the liner strip to the sheet of liner material.

25. The method of claim 24 further comprising attaching the elongated elastic band to the liner strip.

26. The method of claim 20 further comprising attaching the elongated elastic band to the liner material by ultrasonic welding.

27. The method of claim 20 further comprising forming venting holes on the side walls.

28. The method of claim 20 wherein the slow cooker lining system can withstand temperatures of up to about 400° F.

29. A method for making a disposable slow cooker lining system to cover the interior surface of a slow cooking apparatus comprising:
forming a generally tubular, or bag-like shaped liner comprising:
a closed bottom end,
one or more side walls extending upwardly from the closed bottom end, and
an open top end having an exterior diameter;
forming a generally tubular elastic securing band having a first diameter less than the exterior diameter of the open top end;
applying tension to the generally tubular elastic securing band to expand the first diameter to a second diameter wherein the second diameter is greater than the exterior diameter of the open top end; and
securing the elastic securing band to the side walls proximate the open top end.
